(19) United States
(12) Patent Application Publication
(10) Pub. No.: US 2005/0028369 A1
(43) Pub. Date: Feb. 10, 2005

(54) Nostril hair trimmer with rotating cutter blade

(76) Inventors: Nico Cocchiarella, Kehrsiten (CH); Radenko Milakovic, Reussbuehl (CH); Andrew J. Parker, Novato, CA (US)

Correspondence Address: Sheldon R. Meyer;FLIESLER MEYER LLP, Fourth Floor, Four Embarcadero Center, San Francisco, CA, 94111-4156, US

(21) Appl. No.: 10/814,564

(22) Filed: Mar. 31, 2004

Related U.S. Application Data
(60) Provisional application No. 60/459,301, filed on Mar. 31, 2003.

(51) Int. Cl. B26B 19/00

(52) U.S. Cl. 30/29.5

(57) ABSTRACT

A nostril hair trimmer in accordance with one embodiment of the present invention can include a cutter blade comprising a first and second cutter portion with an angle configured in between. The first and second cutter portions are connected to each other by a third cutter portion. A slotted shear plane enclosing the cutter blade allows nostril hairs protruding in different directions to be captured in slots and trimmed short by the cutter blade while protecting nostril membrane. The cutter blade can be arranged such that the cutter blade is rotatable in the slotted shear plane and in constant contact with the inner surface of the slotted shear plane, at least in the region of the slots.

### PRIORITY CLAIM

This application claims priority to the following U.S. Provisional Patent Application:

U.S. Provisional Patent Application No. 60/459,301, entitled “Nostril Hair Trimmer with Rotating Cutter Blade,” Attorney Docket No. SHPR-01362US0, filed Mar. 31, 2003.

### TECHNICAL FIELD

The present invention relates to nostril hair trimmers.

### BACKGROUND

Nostril hair can grow to become an unsightly nuisance requiring trimming from time-to-time. Normal scissors, for example as used for nail trimming or similar cosmetic purposes, can be awkward to use, and can pose a risk of nostril membrane injury since the user has no clear view of where the scissors are sited.

To reduce the risk of injury, electric nostril hair trimmers are often used. Current electric nostril hair trimmers often produce unsatisfactory results, for example by not cutting the nostril hairs close to the nostril membrane, or by not cutting nostril hairs protruding from all sides of the nostril and at different angles.

### BRIEF DESCRIPTION OF THE FIGURES

Further details of embodiments of the present invention are explained with the help of the attached drawings in which:

FIG. 1 is a perspective view of a clipper head in accordance with the invention including a cover for a blade holder;

FIG. 2 is a cross-section of the clipper head shown in FIG. 1;

FIG. 3 is a cross-section of the clipper head shown in FIG. 2, including a cutter blade assembly;

FIG. 4 is a cross-section of the cutter blade assembly shown in FIG. 3;

FIG. 5 is a perspective view of a cutter blade shown in FIG. 4 without a blade holder; and

FIG. 6 is a top view of the cutter blade shown in FIG. 5.

### DETAILED DESCRIPTION

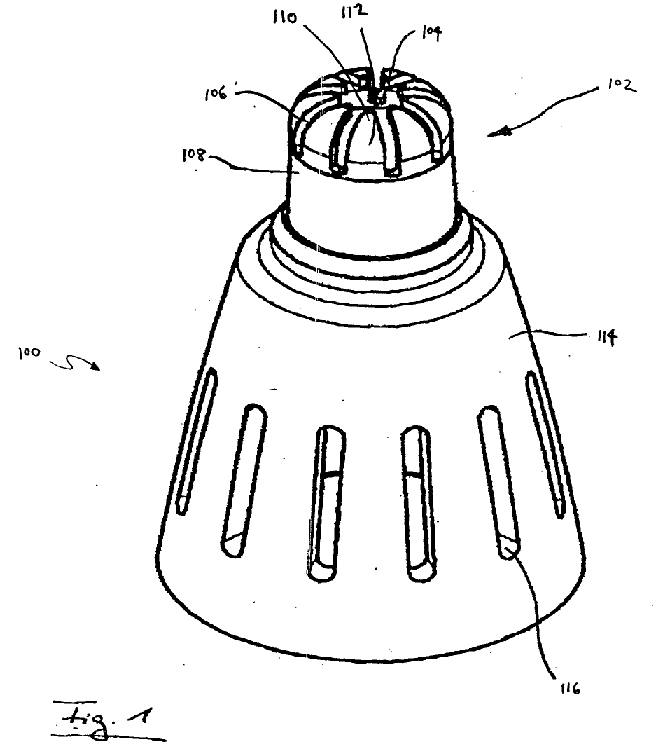

FIG. 1 illustrates a portion of a clipper head 100 for use in a nostril hair trimmer in accordance with one embodiment of the present invention. The clipper head 100 can include a slotted shear plane 102 having slots 106 for receiving nostril hairs for trimming and a blade holder cover 114 connected with the slotted shear plane 102 having slotted apertures 116 through which most of the hairs trimmed by the nostril hair trimmer are blown out of the clipper head 100.

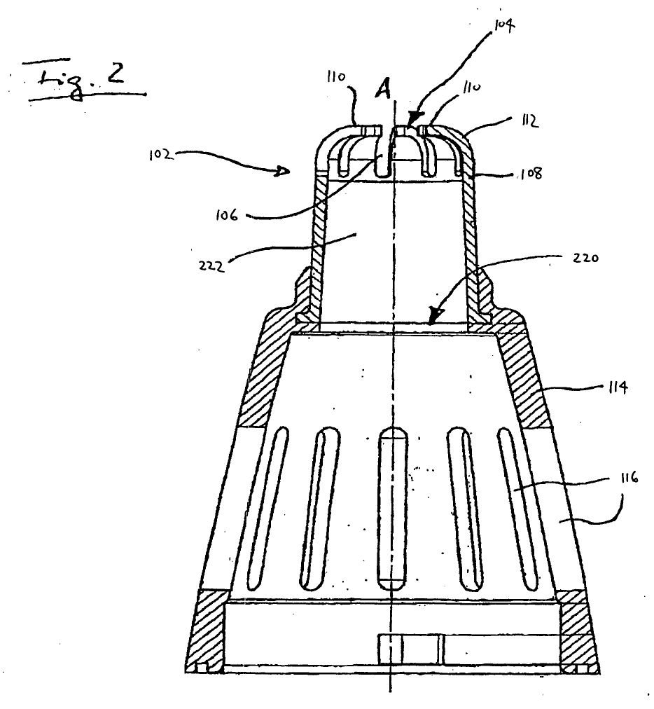

As shown in FIG. 1 and FIG. 2 (in cross-section), the slotted shear plane 102 is embedded positively in the blade holder cover 114 and can have a slightly conical shape with respect to an axis A through a center of the clipper head. The slotted shear plane 102 can be slightly tapered starting from an opening 220 through which a cutter blade projects, to the end of a shell portion 108 which can translate via a transition portion rounded into an end portion approximately perpendicular to the axis A. An angle of the taper between the slotted shear plane 102 and the axis A can be very slight, for example, approximately 2.2°. In other embodiments, however, the angle of the taper can be larger or smaller, and one of ordinary skill in the art can appreciate that the invention should not be construed as being limited by the angle of the taper. In still other embodiments, the slotted shear plane 102 and blade holder cover 114 can be a single piece. In still other embodiments, the slotted shear plane 102 can be shaped to conform to the contours of a nostril.

The tip of the clipper head 110 comprises a round port 104 centered about the axis A. Nine slots 106 extend from the round port 104, and are arranged symmetrically such that a star-burst pattern is formed. The slots 106 can be configured so that each slot 106 is located in a plane intersecting the axis A. In other embodiments, the tip of the clipper head 110 can have any number of slots that can be symmetrically or asymmetrically arranged.

The slotted shear plane 102 can comprise stainless steel, so that the slotted shear plane 102 does not rust when coming into contact with moisture in the nostril. The end of the shell portion 100 can be deburred, and the edges of the slots 106 as well as the round port 104 can be deburred and/or rounded, there by reducing the risk of injury to nostril membrane upon nostril insertion of the slotted shear plane 102. Alternatively, the slotted shear plane 102 can comprise other materials, for example other metals or plastic. Further, as mentioned above, any number of slots 106 can be formed in the slotted shear plane 102, and the invention should not be construed as being limited to nine slots 106. Likewise, the port 104 can also be configured having a shape other than round.

The blade holder cover 114 can comprise a plurality of apertures 116 through which most of the hairs trimmed by the nostril hair trimmer can be blown out of the cutting head 100. The blade holder cover 114 can comprise plastic, or alternatively other materials having similar rigid properties, for example stainless steel.

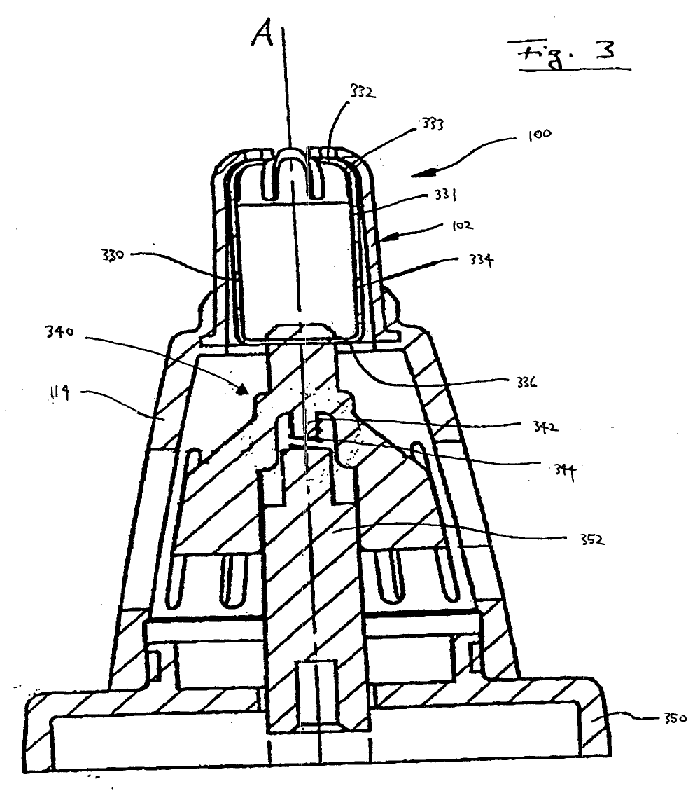

A cross-section of a clipper head 100 including a cutter blade assembly comprising a cutter blade 330 mounted on a blade holder 340 is shown in FIG. 3. The clipper head 100 is releasably connected to a motor casing 350 via the blade holder cover 114. A portion of the motor casing 350 connecting the blade holder cover 114 and the motor casing 350 is shown. Additionally, the motor casing 350 can form a finger grip (not shown) for holding the nostril hair trimmer. Protruding from the motor casing 350 along the axis A is a motor shaft 352 which can rotate about the axis A. The motor shaft 352 can be connected with the blade holder 340 by a spring 344 which in turn is connected with a lug 342. The blade holder 340 (and by extension the cutter blade 330) can be urged axially about the axis A by the motor shaft 352.

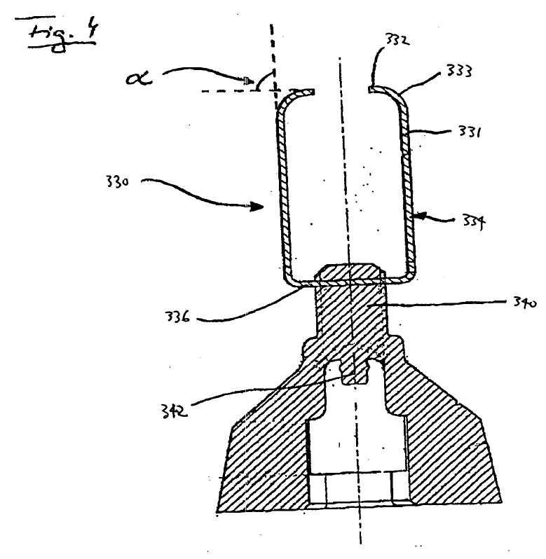

FIG. 4 is a cross-section of a cutter blade assembly showing the cutter blade 330 having a U-shaped configuration connected with the blade holder 340 along abase 336 of the cutter blade 330. The U-shaped cutter blade can be rotated within the nostril hair trimmer about an axis of symmetry, thereby eliminating or reducing any tendency to wobble on rotation. The blade holder 340 can comprise plastic, and the cutter blade 330 can be potted in the upper portion of the blade holder 340, or alternatively the blade holder 340 can be injection molded around the cutter blade 330. In other embodiments, the blade holder 340 can comprise metal, or some other material having rigid properties. In still other embodiments, a cutter blade 330 having a single blade edge forming an L-shaped configuration can be used. In still other embodiments, a cutter blade 330 having three or more blade edges can be used. In still other embodiments, a cutter blade 330 having a single blade edge forming an O-shaped configuration, or a rectangular loop can be used. One of ordinary skill in the art can appreciate the myriad of different configurations for the cutter blade 330.

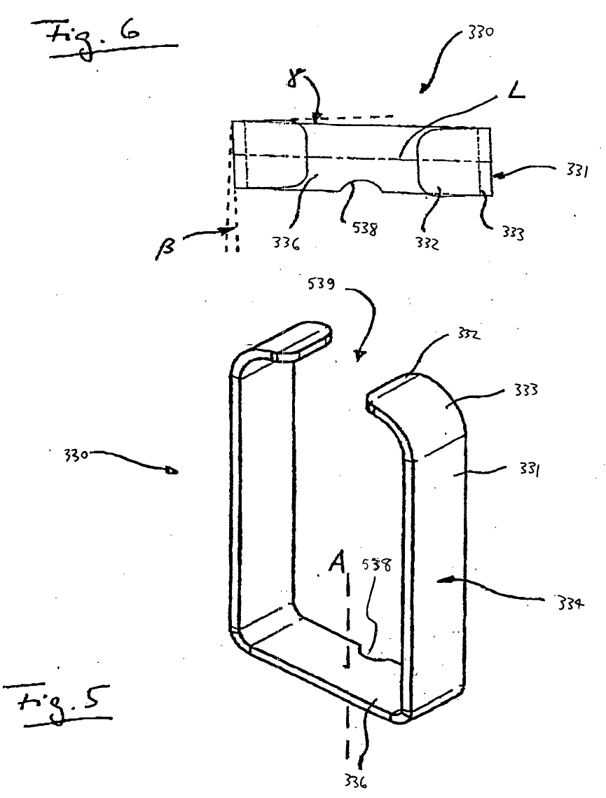

One embodiment of the cutter blade 330 is particularly illustrated in FIGS. 4, 5 and 6. A recess 538 can be formed in the base 332 of the cutter blade 330 to provide a connection between the base 336 of the cutter blade 330 and the upper end of the cutter blade holder 340. The recess 538 prevents the cutter blade 330 from slipping along the longitudinal axis L of the base 336 in the upper end of the blade holder 340. In other embodiments, a slot or mounting hole can be formed, thus restricting movement in multiple directions of the cutter blade 330 in the cutter blade holder 340.

The two legs (or edges) 334 can each be connected to the base 336 of the cutter blade 330 and oriented substantially perpendicular to the base 332 of the cutter blade 330, resulting in a substantially vertical first cutter portion 331. The first cutter portion 331 translates via a rounded third cutter portion 333 into a second cutter portion 332. An angle formed between the first cutter portion 331 and the second cutter portion 332 (the angle of flexure α), as shown can be approximately 90°, resulting in the second cutter portion 332 being oriented substantially perpendicular to the first cutter portion 331. In other embodiments the angle of flexure can be between 80° and 100°. Configured between the two second cutter portions 332 is an end aperture 539 sized so that the cutter blade 330 does not protrude beyond the port 104 in the slotted shear plane 102. This arrangement can prevent risk of injury from the rotating cutter blade 330 by preventing skin from coming into direct contact with the cutter blade 330. Relative to a vertically positioned axis A, the horizontal orientation of the second cutter portion 332 and the vertical orientation of the first cutter portion 331 allows nostril hair projecting into the nostril hair trimmer, including nostril hairs projecting both substantially horizontally and substantially vertically, to be trimmed by the cutter blade 330. In addition, nostril hair projecting into the nostril hair trimmer in the region of the rounded third cutter portion 333 can be trimmed.

The dimensions of the cutter blade 330 can be configured based on the dimensions of the slotted shear plane 102 as described above so that the cutter blade 330 can be positively urged by the spring 344 toward an upper portion of the slotted shear plane 102. For example, the dimensions of the cutter blade 330 can substantially conform to the dimensions of the slotted shear plane 102. In this way, at least the first cutter portion 331 of the cutter blade 330 can be in direct contact with the inner surface 222 of the slotted shear plane 102. The cutter blade 330 can be configured such that the rounded third cutter portion 333 and the second cutter portion 332 of the blade directly contacts the inner surface of the slotted shear plane 102 as well. By conforming the cutter blade 330 to the dimensions of the shell portion 108 of the slotted shear plane 102, it is possible to trim nostril hair projecting into the clipper head 100 very short since no air gap can form between the cutter blade 330 and slotted shear plane 102 in the region of the slots 106. However, in some other embodiments, it maybe preferred that there be some small distance between the cutting blade and the shell portion 108.

FIG. 6 illustrates a cutter blade 330 in accordance with one embodiment of the present invention in which the first cutter portion 331 and second cutter portion 332 rotate out of the longitudinal axis L of the base 336. The first cutter portion 331 can be twisted by a first torsion angle β against an orthogonal plane to the longitudinal axis L of the base 336. The first torsion angle, for example, can be approximately 3.2°; however, in other embodiments, the first torsion angle can be larger or smaller. In this way, the clipper edge of the cutter blade can cut along a slotted shear plane. Twisting about the first torsion angle β in the region of the first cutter portion 331 also causes twisting of the second cutter portion 332 and third cutter portion 333 relative to the base 336, forming a second torsion angle γ between the second cutter portion 332 and the base 336. For a vertical orientation of the first cutter portion 331 and horizontal orientation of the second cutter portion 332 (corresponding to an angle of flexure α of 90°), this second torsion angle γ will be the same as the first torsion angle β, i.e. 3.2°. Other smaller or larger angles β, γ are also possible. Where the angle of flexure a is precisely 90° the two torsion angles β and γ can differ.

The cutter blade 330 can comprise a strip of stainless steel hardened to 40HRC. The strip can have a width of 2 mm and a length of approximately 33 mm. The strip can be approximately 0.3 mm thick. Alternatively, the cutter blade 330 can comprise other grades of steel having different hardness. Likewise, the strip can easily have different dimensions to accommodate the required dimensioning of the inner surface 222 of the slotted shear plane 102, as well as to accommodate the cost and quality considerations of the nostril hair trimmer. Further, the cutter blade 330 can be treated for a hard finish and/or can be coated in at least the first, second and third cutter portions. By having a hard finish and/or coating, the cutter blade can be made less susceptible to blunting. Reduced blunting can result in a lower frequency of cutter blade 330 replacement (or replacement of the entire nostril hair trimmer), thereby reducing costs.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

1. A nostril hair trimmer, comprising:
a housing;
a motor connected with the housing;
a blade holder connected with the motor, such that the blade holder can be rotated about an axis; and
at least one cutter blade connected with the blade holder, the at least one cutter blade including:
a first cutter portion; and
a second cutter portion connected with the first cutter portion by a third cutter portion such that the second cutter portion forms an angle with the first cutter portion.

2. The nostril hair trimmer of claim 1, further comprising:
a shell connected with the housing, the shell including at least one slot for receiving a nostril hair;
wherein the shell is adapted to form a shear plane such that the nostril hair entering the at least one slot can be sheared off as the at least one cutter blade rotates, thereby trimming the nostril hair.

3. The nostril hair trimmer of claim 2, further comprising:
a blade holder cover connected between the housing and the shell, the blade holder cover including at least one aperture for expelling trimmed nostril hairs.

4. The nostril hair trimmer of claim 3, further comprising:
a spring connected between the blade holder and the motor;
wherein the spring is adapted to apply a force to the blade holder such that the at least one cutter blade contacts an inner surface of the shell.

5. The nostril hair trimmer of claim 4, wherein the housing is adapted to form a grip.

6. The nostril hair trimmer of claim 1, wherein the angle formed between the first cutter portion and the second cutter portion is between 80° and 100°.

7. The nostril hair trimmer of claim 1, wherein the angle formed between the first cutter portion and the second cutter portion is 90°.

8. The nostril hair trimmer of claim 1, wherein the third cutter portion is rounded.

9. The nostril hair trimmer of claim 1, wherein the second cutter portion and the third cutter portion are oriented such that a second angle is formed between the second cutter portion and a line tangential to a circle traced by the cutter blade.

10. The nostril hair trimmer of claim 9, wherein the second angle is 2.2°

11. A nostril hair trimmer, comprising:
a motor casing;
a motor connected with the motor casing;
a blade holder connected with the motor, such that the blade holder can be rotated about an axis;
a cutter blade connected with the blade holder;
a housing connected with the motor casing, the housing including:
a blade holder cover having at least one aperture;
a shell connected with the blade cover, the shell having at least one slot for receiving a nostril hair;
wherein the shell is adapted to form a shear plane such that the nostril hair entering the at least one slot can be sheared off as the cutter blade rotates, thereby trimming the nostril hair.

12. The nostril hair trimmer of claim 11, further comprising:
a spring connected between the blade holder and the motor;
wherein the spring is adapted to apply a force to the blade holder such that the cutter blade contacts an inner surface of the shell.

13. The nostril hair trimmer of claim 11, wherein the cutter blade includes:
a base positioned perpendicular to the axis, the base having a first end and a second end;
a first edge connected with the first end of the base; and
a second edge connected with the second end of the base;
wherein each edge includes:
a first cutter portion extending parallel to the axis; and
a second cutter portion connected with the first portion by a third cutter portion such that an angle is formed between the first cutter portion and the second cutter portion;
wherein the second cutter portion extends toward a center of rotation;
wherein the third cutter portion is shaped like an elbow.

14. The nostril hair trimmer of claim 13, wherein the angle formed between the first cutter portion and the second cutter portion is between 80° and 100°.

15. The nostril hair trimmer of claim 13, wherein the second cutter portion and the third cutter portion are oriented such that a second angle is formed between a longitudinal line of the base and a longitudinal line of the second portion.

16. The nostril hair trimmer of claim 11, wherein the cutter blade includes:
a continuous edge having a proximal end and a distal end, the continuous edge forming a rectangular loop having rounded corners at the distal end.

17. The nostril hair trimmer of claim 16, wherein the distal end is twisted such that an angle is formed between a longitudinal line of the proximal end and a longitudinal line of the distal end.

18. A nostril hair trimmer, comprising:
a motor casing;
a motor connected with the motor casing;
a blade holder connected with the motor, such that the blade holder can be rotated about an axis;
a cutter blade connected with the blade holder, the cutter blade including:
a base positioned perpendicular to the axis, the base having at least one arm extending radially from the axis;
an edge connected with each of the at least one arms;
wherein each edge includes:
a first cutter portion extending parallel to the axis; and
a second cutter portion connected with the first cutter portion by a third cutter portion such that an angle is formed between the first cutter portion and the second cutter portion;
wherein the second cutter portion extends toward a center of rotation;
wherein the third cutter portion is shaped like an elbow.
a housing connected with the motor casing, the housing including:
a blade holder cover having at least one aperture;
a shell connected with the blade cover, the shell having at least one slot for receiving a nostril hair and a port at a tip of the shell;
wherein the shell is adapted to form a shear plane such that the nostril hair entering the at least one slot can be sheared off as the cutter blade rotates, thereby trimming the nostril hair.
a spring connected between the blade holder and the motor;
wherein the spring is adapted to apply a force to the blade holder such that the cutter blade contacts an inner surface of the shell.

19. The nostril hair trimmer of claim 13, wherein the angle formed between the first cutter portion and the second cutter portion is between 80° and 100°.

20. The nostril hair trimmer of claim 13, wherein the second cutter portion and the third cutter portion are oriented such that a second angle is formed between a longitudinal line of the base and a longitudinal line of the second portion.
